(19) United States
(12) Patent Application Publication
(10) Pub. No.: US 2024/0020768 A1
(43) Pub. Date: Jan. 18, 2024

(54) DRIVER EVALUATION APPARATUS, INSURANCE PREMIUM CALCULATION SYSTEM, METHOD AND COMPUTER-READABLE MEDIUM

(71) Applicant: NEC Corporation, Minato-ku, Tokyo (JP)

(72) Inventor: Shinichiro Sumi, Tokyo (JP)

(73) Assignee: NEC Corporation, Minato-ku, Tokyo (JP)

(21) Appl. No.: 18/265,157

(22) PCT Filed: Dec. 11, 2020
(86) PCT No.: PCT/JP2020/046317

§ 371 Date: Jun. 2, 2023

(51) Int. Cl. G06Q 40/08

(52) U.S. Cl. CPC G06Q 40/08

(57) ABSTRACT

A route acquisition means acquires route information indicating a route on which a driver has driven a vehicle. A route assessment means carries out assessment of a degree of traveling danger in the route based on the route information acquired by the route acquisition means and road characteristics information of roads in the route on which the vehicle travels. A driver evaluation means evaluates driver characteristics of the driver based on a result of the assessment of the route carried out by the route assessment means.

### TECHNICAL FIELD

The present disclosure relates to a driver evaluation apparatus, an insurance premium calculation system, method, and a computer-readable medium.

### BACKGROUND

As a related technology, Patent Literature 1 discloses a driving evaluation system for evaluating driving of a driver of a vehicle. In the driving evaluation system described in Patent Literature 1, a traveling data processing unit acquires traveling data from a vehicle. The traveling data includes the traveling speed of the vehicle, the engine rpm of the vehicle, information on the date and time when the vehicle is traveling, the location information of the vehicle, and the acceleration information of the vehicle. The evaluation processing unit generates evaluation data indicating the evaluation results of evaluation items related to the traveling condition of the vehicle based on the traveling data acquired by the traveling data processing unit. The evaluation items include history information of unusual events such as sudden braking or sudden acceleration, and speeding.

In Patent Literature 1, the evaluation data is output to an insurance premium calculation apparatus of an insurance company. The insurance premium calculation apparatus uses the evaluation data to determine, for example, the discount rate of the insurance premium. The better the evaluation result, the higher the discount rate is set. In this case, the driver will always try to drive more safely in order to get a higher discount rate. Therefore, in Patent Literature 1, the insurance premium discount rate contributes to enhancing driver's motivation to drive safely.

As another related art in connection with safe driving, Patent Literature 2 discloses a self-driving vehicle with a route determination unit that determines a route the vehicle can travel safely. In Patent Literature 2, a route determination unit calculates a candidate route on which a self-driving vehicle is to travel. In calculating a route candidate, a route determination unit refers to high-precision map data and calculates a plurality of route candidates using an arbitrary route search algorithm based on search conditions such as the required traveling time from the current location to the destination, distance, traffic congestion, and number of right and left turns.

The route determination unit evaluates the degree of danger for each of the calculated route candidates. The degree of danger includes an index for evaluating the degree of danger of the self-driving vehicle coming into contact with or colliding with other objects while traveling. The route determination unit evaluates the degree of danger based on the lane information such as, for example, the shape, the inclination, and the configuration of the travel lane of the road included in the route candidates. The route determination unit also evaluates the degree of danger based on the road feature information such as crosswalks, school zones, cyclist zones, and centerline poles present in the route candidate. The route determination unit evaluates intersections, locations where traffic accidents have occurred frequently in the past, locations where vehicles have collided or nearly collided in the past, roads where emergency vehicles frequently travel, and roads where children or the elderly frequently pass by, as areas of high degree of danger. The route determination unit determines the candidate whose evaluated degree of danger is lower than a prescribed threshold as the route to be taken.

### CITATION LIST

### Patent Literature

Patent Literature 1: Japanese Unexamined Patent Application Publication No. 2019-174861

Patent Literature 2: Japanese Unexamined Patent Application Publication No. 2018-155577

### SUMMARY OF INVENTION

### Technical Problem

In related technologies, including Patent Literature 1, the driving skills of the driver is evaluated based on the traveling data, and the insurance premium (the discount rate of the insurance premium) is determined according to the driving skills. However, it is unclear whether the driver with high driving skills actually tries to drive safely. Even drivers with high driving skills who drive in high-risk areas have the potential to cause traffic accidents.

In Patent Literature 2, the route determination unit evaluates the degree of danger in each candidate route and selects the route of lower risk among the candidate routes. However, in Patent Literature 2, the route determination unit determines the route on which the self-driving vehicle travels. Therefore, the degree of danger in the route which the self-driving vehicle traveled is not related to the characteristics of the driver.

In view of the above, an object of the present disclosure is to provide a driver evaluation apparatus, an insurance premium calculation system, a driver evaluation method, and a computer-readable medium each adapted to evaluate a driver according to the route which the driver took in driving a vehicle.

### Solution to Problem

To achieve the above object, the present disclosure provides, as a first aspect, a driver evaluation apparatus. The driver evaluation apparatus includes a route acquisition means for acquiring route information of a route on which a driver drives a vehicle; a route assessment means for carrying out assessment of a degree of traveling danger in the route based on the route information and road characteristics information of roads in the route on which the vehicle travels; and a driver evaluation means for evaluating driver characteristics of the driver based on a result of the assessment of the route.

The present disclosure provides, as a second aspect, an insurance premium calculation system. The insurance premium calculation system includes: a driver evaluation apparatus that evaluates driver characteristics of a driver who is driving a vehicle; and an insurance premium calculation apparatus. The driver evaluation apparatus includes: a route acquisition means for acquiring route information of a route on which the driver drives the vehicle; a route assessment means for carrying out assessment of a degree of traveling danger in the route based on the route information and road characteristics information of roads in the route on which the vehicle travels; and a driver evaluation means for evaluating the driver characteristics of the driver based on a result of the assessment of the route. The insurance premium calculation apparatus is configured to acquire the driver characteristics from the driver evaluation apparatus and calculate an insurance premium of the vehicle driven by the driver based on the driver characteristics acquired from the driver evaluation apparatus.

The present disclosure provides, as a third aspect, a driver evaluation method. The driver evaluation method includes: acquiring route information of a route on which a driver drives a vehicle; carrying out assessment of a degree of traveling danger in the route based on the route information and road characteristics information of roads in the route on which the vehicle travels; and evaluating driver characteristics of the driver based on a result of the assessment of the route.

The present disclosure provides, as a fourth aspect, a computer-readable medium. The computer-readable medium stores a program for causing a computer to execute processes of: acquiring route information of a route on which a driver drives a vehicle; carrying out assessment of a degree of traveling danger in the route based on the route information and road characteristics information of roads in the route on which the vehicle travels; and evaluating driver characteristics of the driver based on a result of the assessment of the route.

### Advantageous Effects of Invention

In view of the aforementioned circumstances, a driver evaluation apparatus, an insurance premium calculation system, a driver evaluation method, and a computer-readable medium according to the present disclosure are adapted to evaluate a driver according to the route which the driver took in driving a vehicle.

### BRIEF DESCRIPTION OF DRAWINGS

FIG. 1 is a block diagram showing a schematic configuration of an insurance premium calculation system according to the present disclosure;

FIG. 2 is a block diagram showing an insurance premium calculation system according to a first example embodiment in the present disclosure;

FIG. 3 is a block diagram showing an example of a configuration of a driver evaluation apparatus;

FIG. 4 is a diagram showing a display example of a route selection screen in a user device;

FIG. 5 is a flowchart illustrating operating procedures for performing driver evaluation in an insurance premium calculation system;

FIG. 6 is a flowchart illustrating operating procedures for performing insurance premium calculation in an insurance premium calculation system;

FIG. 7 is a block diagram showing a driver evaluation apparatus as used in a second example embodiment of the present disclosure; and

FIG. 8 is a block diagram showing an example of a configuration of a computer apparatus.

### EXAMPLE EMBODIMENT

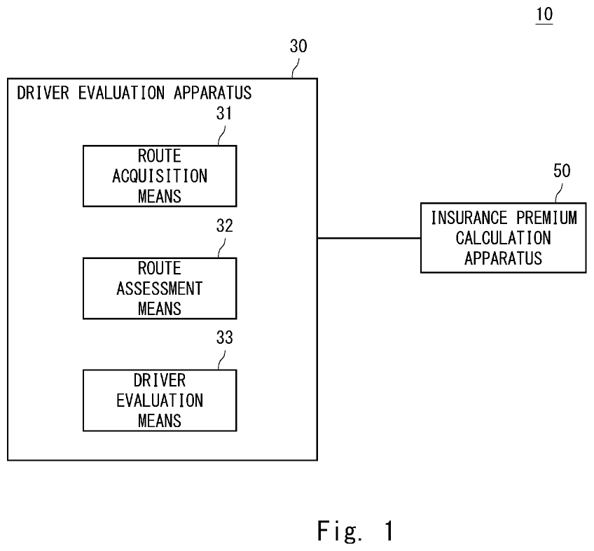

An overview of the present disclosure is provided prior to the description of the example embodiments of the present disclosure. FIG. 1 shows a schematic structure of an insurance premium calculation system according to the present disclosure. An insurance premium calculation system 10 includes a driver evaluation apparatus 30 and an insurance premium calculation apparatus 50. The driver evaluation apparatus 30 has a route acquisition means 31, a route assessment means 32, and a driver evaluation means 33.

In the driver evaluation apparatus 30, the route acquisition means 31 acquires route information indicating the route on which a driver drives a vehicle. The route assessment means 32 carries out assessment of the degree of traveling danger in the route based on the route information and the road characteristics information of the road on which the vehicle travels. The driver evaluation means 33 evaluates the driver's driver characteristics based on the result of the assessment of the route. The insurance premium calculation apparatus 50 acquires the driver characteristics from the driver evaluation apparatus 30. The insurance premium calculation apparatus 50 calculates the insurance premium of the vehicle driven by the driver based on the acquired driving characteristics.

In the present disclosure, the route assessment means 32 uses the road characteristics information to carry out assessment of the degree of traveling danger in a route. The driver evaluation means 33 evaluates the driving characteristics of the driver based on the degree of traveling danger in the route on which the driver drives the vehicle. The driver evaluation apparatus 30 can evaluate whether the driver drives the vehicle on a route with a high degree of traveling danger or a route with a low degree of traveling danger, and can evaluate the driver according to the route which the driver took in driving the vehicle. The insurance premium calculation apparatus 50 determines the insurance premium based on the evaluation results of such driver characteristics. By doing so, it becomes possible to discount the insurance premium for a driver who tries to drive safely.

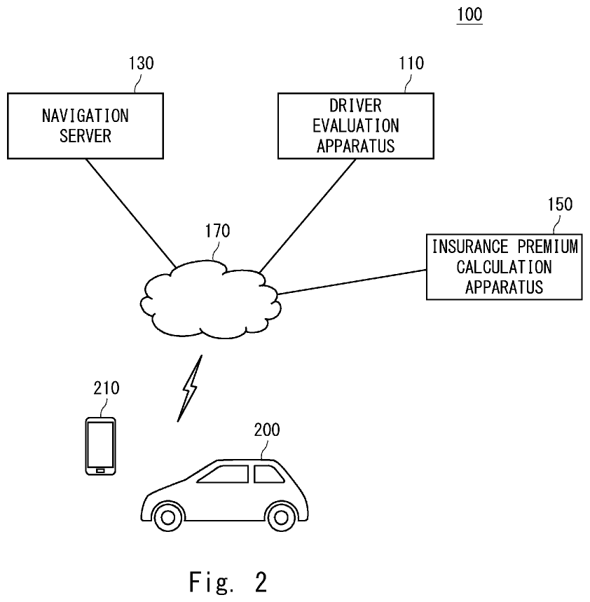

Example embodiments of the present disclosure will be described in detail below. FIG. 2 shows insurance premium calculation system according to a first example embodiment of the present disclosure. An insurance premium calculation system 100 includes a driver evaluation apparatus 110, a navigation server 130, an insurance premium calculation apparatus 150, and a user device 210. The insurance premium calculation system 100 corresponds to the insurance premium calculation system 10 shown in FIG. 1.

In the insurance premium calculation system 100, the driver evaluation apparatus 110, the navigation server 130, and the insurance premium calculation apparatus 150 are connected with one another via a network 170. Furthermore, the driver evaluation apparatus 110, the navigation server 130, and the insurance premium calculation apparatus 150 are connected to the vehicle 200 and the user device 210 via the network 170. The network 170 includes, for example, a wireless communication network that uses a communication line standard such as an LTE (Long Term Evolution). The network 170 may include a wireless communication network such as WiFi® or a 5th generation mobile communication system.

The user device 210 is configured as a portable information communication device such as a smart phone used by the driver (the user) of the vehicle 200. The user device 210 may be an information communication device mounted on the vehicle 200. The user device 210 includes a processor and a memory. In the user device 210, various functions in the user device 210 are realized by executing processing according to a program read from the memory by the processor. The user device 210 includes a display device such as a liquid crystal display device, and displays various kinds of information on the display screen.

The vehicle 200 is a vehicle operated by the user. The vehicle 200 is configured as a land vehicle, such as a car, bus, taxi, truck, or two-wheeled vehicle. In this example embodiment, it is assumed that the user uses the user device 210 when he/she is in the vehicle 200. The user device 210 has a location measurement unit that measures the location of the vehicle using, for example, a system such as GNSS (Global Navigation Satellite System). The user device 210 transmits the location information measured by, for example, the location measurement unit, that is, the location information of the vehicle 200, to the navigation server 130.

The navigation server 130 is a server that provides the service of route search and route guidance of the vehicle 200 to the user device 210. The navigation server 130 receives a route search request from the user device 210. The route search request includes, for example, the current location (a departure place) and a destination place of the vehicle 200. The navigation server 130 references the map information and performs route search for a route from the departure place to the destination place using a known algorithm. In the route search, the navigation server 130 can acquire a plurality of routes (route candidates) with the same departure place and the same destination place but different waypoints. The navigation server 130 transmits the route search result to the user device 210. When the user determines which route to take, the navigation server 130 starts the route guidance.

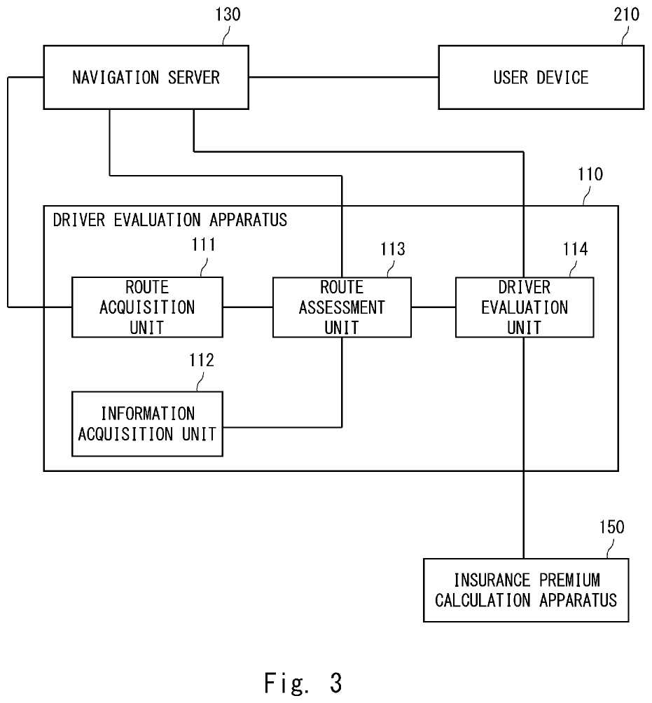

The driver evaluation apparatus 110 is an apparatus for evaluating the driving characteristics (driver characteristics) of the user. FIG. 3 shows an example of the configuration of the driver evaluation apparatus 110. The driver evaluation apparatus 110 has a route acquisition unit 111, an information acquisition unit 112, a route assessment unit 113, and a driver evaluation unit 114. The driver evaluation apparatus 110 corresponds to the driver evaluation apparatus 30 shown in FIG. 1.

The route acquisition unit 111 acquires route information indicating the route retrieved as a result of the route search from the navigation server 130. When a plurality of routes with the same departure place and the same destination place and different waypoints are retrieved from the navigation server 130, the route acquisition unit 111 acquires route information of the plurality of routes. The route acquisition unit 111 corresponds to the route acquisition means 31 shown in FIG. 1.

The information acquisition unit 112 acquires road characteristics information of the road on which the vehicle travels. The information acquisition unit 112 acquires, for example, at least one of information indicating the occurrence status of past traffic accidents (accident statistics information), information indicating the pavement condition of the road surface, and information indicating the width of the road as road characteristics information. The information acquisition unit 112 may acquire accident statistics and information indicating the pavement condition of the road surface from open data published by, for example, an administrative body or a municipality. The information acquisition unit 112 may acquire information indicating the width of the road from map information.

The route assessment unit 113 carries out assessment of the degree of traveling danger in the route based on the route information acquired by the route acquisition unit 111 and the information acquired by the information acquisition unit 112. When the route information is acquired in the route acquisition unit 111, the route assessment unit 113 carries out assessment of the degree of traveling danger in each of the plurality of routes. The route assessment unit 113 calculates, for example, an index indicating the traveling difficulty or the degree of traveling danger when a vehicle travels on the selected route as an assessment value. Alternatively, the route assessment unit 113 may calculate as an assessment value an index indicating ease of travel or road safety when a vehicle travels on the selected route. In the following explanation, it is assumed that the route assessment unit 113 calculates the degree of risk as an index indicating the traveling difficulty or the degree of traveling danger. The route assessment unit 113 corresponds to the route assessment means 32 shown in FIG. 1.

The route assessment unit 113 refers to accident statistics, for example, and checks whether the route includes a location where a traffic accident may occur. If the route includes a location where traffic accidents occur frequently, the route assessment unit 113 assesses the route as having a high degree of risk. The route assessment unit 113 also checks whether or not the route includes a location where pavement condition is poor, such as a many cracks or potholes. If the route includes a location where pavement condition is poor, the route assessment unit 113 assesses the route as having a high degree of risk. The route assessment unit 113 checks whether the route includes a location where the widths of the roads are narrow. The route assessment unit 113 may determine a road having a narrow road width using, for example, information indicating whether the road is a one-way or a two-way traffic and information indicating the road width. The route assessment unit 113 may determine, for example, that a width of a road is narrow if the road is a one-way traffic and the road is not wide enough for the whole vehicle width. The route assessment unit 113 may determine that a width of a road is narrow if the road is a two-way traffic and the road is too narrow for vehicles to pass by each other. The route assessment unit 113 assesses a route as having a high degree of risk if the route includes a location where the widths of the roads are narrow. The route assessment unit 113 totals the degree of risk at each location included in the route and calculates the degree of risk in the route. The route assessment unit 113 calculates the degree of risk in the route according to the number of locations included in the route where traffic accidents occur frequently, where pavement conditions are poor, and where the widths of the roads are narrow.

In addition to the road characteristics information, the information acquisition unit 112 may acquire weather data of the road on which the vehicle travels. The information acquisition unit 112 can acquire weather data, for example, from an external server that provides weather information. The information acquisition unit 112 may acquire weather data from the vehicle 200 or the user device 210. In this case, the route assessment unit 113 may use the weather data to carry out assessment of the degree of traveling danger in the route. The route assessment unit 113 will assess a route as having a high degree of risk if, for example, the route includes a location where traffic accidents occur frequently in the weather indicated by the acquired weather data. The route assessment unit 113 may raise the degree of traveling danger in the route if the weather data indicates rain or snow.

The route assessment unit 113 may also consider the time of day and the day of the week when the vehicle travels on the route in carrying out the assessment of the degree of traveling danger in the route. The route assessment unit 113 may refer to accident statistics when, for example, the time of the day when the vehicle travels on the route is during the nighttime, identify the location where traffic accidents occur frequently during the night time and carry out assessment of the degree of traveling danger in the route. It may be evaluated. The route assessment unit 113 may refer to accident statistics to identify locations where traffic accidents occur frequently on the days of the week on which vehicles travel the route and carry out assessment of the degree of traveling danger in the route. The route assessment unit 113 transmits the result of the assessment of each route to the navigation server 130.

The navigation server 130 receives the result of the assessment of each route from the driver evaluation apparatus 110. In the transmission of the route search result, the navigation server 130 transmits the route information and the degree of risk (the evaluation result) received from the driver evaluation apparatus 110 to the user device 210. The user device 210 displays the route and the degree of risk on the display screen to prompt the user to select the route. For the plurality of routes (candidates), the user device 210 displays the distance of each route, the required traveling time, and the degree of risk. The user selects the travel route of the vehicle 200 (see, FIG. 2) from the displayed routes.

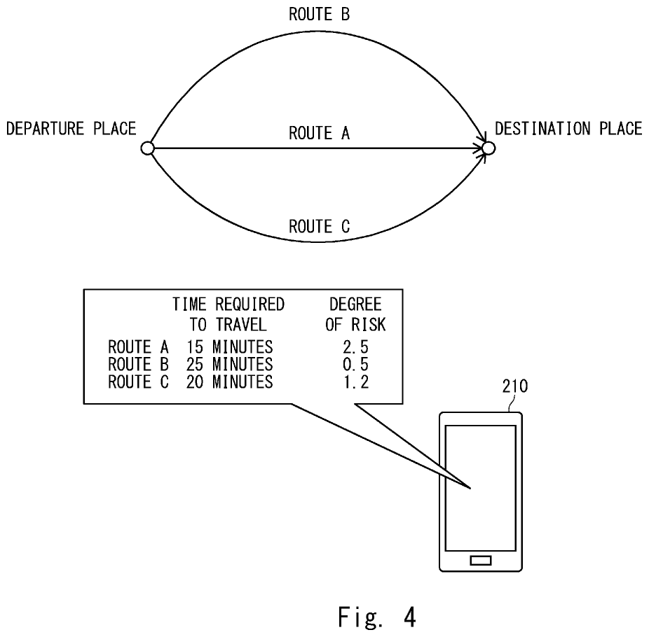

FIG. 4 shows a display example of the route selection screen in the user device 210. Assume that the navigation server 130 searches three routes of Route A, Route B, and Route C, as routes from the departure place to the destination place. In the example of FIG. 4, the user device 210 presents to the user “15 minutes” for the required traveling time and “2.5” for the degree of risk for Route A. The user device 210 also presents to the user “25 minutes” for the required traveling time and “0.5” for the degree of risk for Route B. The user device 210 presents to the user “20 minutes” for the required traveling time and “1.2” for the degree of risk for Route C. The user can decide on the route considering the required traveling time and the degree of risk.

For example, among the three routes, Route A has the shortest required traveling time. However, Route A has a high degree of risk because it includes a traffic accident-prone area or the widths of the roads are narrow. The user chooses Route A if the distance or the required traveling time is of a priority. The user can choose Route B or Route C having a low degree of risk even if the required traveling time is somewhat longer, if the user has time to spare. The degree of risk in the route selected by the user is considered to be related to the user's attitude toward safe driving. For example, the user who chooses the route with a low degree of risk is considered to be trying to drive in a way that reduces the risks.

Referring again to FIG. 3, the driver evaluation unit 114 acquires information on the route selected by the user from the navigation server 130. The driver evaluation unit 114 evaluates the driver characteristics of the user based on the results of the assessment carried out by the route assessment unit 113 for the route selected by the user. The driver evaluation unit 114 calculates, for example, an index indicating the user's safe driving level as an evaluation value. The evaluation value is assumed to be such that, for example, the lower the degree of risk in the route selected by the user, the larger the value. The driver evaluation unit 114 corresponds to the driver evaluation means 33 shown in FIG. 1.

The driver evaluation unit 114 may evaluate the driver characteristics based on the difference or the ratio between the degree of risk in the route selected by the user and the degree of risk in the routes that are not selected by the user among the plurality of routes presented to the user. For example, if the user selects a route with a relatively low degree of risk, the driver evaluation unit 114 may assume that the user is trying to drive safely and evaluate the user as having a high safe driving level. If the user selects a route having a relatively high degree of risk, the driver evaluation unit 114 may assume that the user is not trying to drive safely and evaluate the user as having a low safe driving level.

The driver evaluation unit 114 may acquire location information of the vehicle 200 from, for example, the navigation server 130, and determine whether or not the vehicle 200 is traveling on the route selected by the user based on the location information. Whether or not the vehicle 200 is traveling on the route selected by the user may be determined by the navigation server 130. When it is determined that the vehicle 200 is not traveling on the route selected by the user, the driver evaluation unit 114 may re-evaluate the degree of traveling danger in the route on which the vehicle 200 is traveling.

The driver evaluation unit 114 outputs the evaluation result of the driver characteristics to the insurance premium calculation apparatus 150 which calculates the insurance premium of the automobile insurance. The insurance premium calculation apparatus 150 acquires the driver characteristics from the driver evaluation apparatus 110 and calculates the insurance premium of the vehicle 200 driven by the user based on the acquired driving characteristics. The insurance premium calculation apparatus 150 calculates, for example, the discount rate of the insurance premium to the base rate of the insurance based on the driver characteristics. For example, the insurance premium calculation apparatus 150 increases the discount rate for users with a high safe driving level. The insurance premium calculation apparatus 150 may reduce the discount rate for users with a low safe driving level. The insurance premium calculation apparatus 150 corresponds to the insurance premium calculation apparatus 50 shown in FIG. 1.

The driver evaluation apparatus 110 and the insurance premium calculation apparatus 150 do not necessarily have to be configured as separate apparatuses. For example, the driver evaluation apparatus 110 may be included in the insurance premium calculation apparatus 150, and the insurance premium calculation apparatus 150 may have the functions of the driver evaluation apparatus 110. In addition, the driver evaluation apparatus 110 and the navigation server 130 need not necessarily be configured as separate apparatuses. The navigation server 130 may include the functions of the driver evaluation apparatus 110.

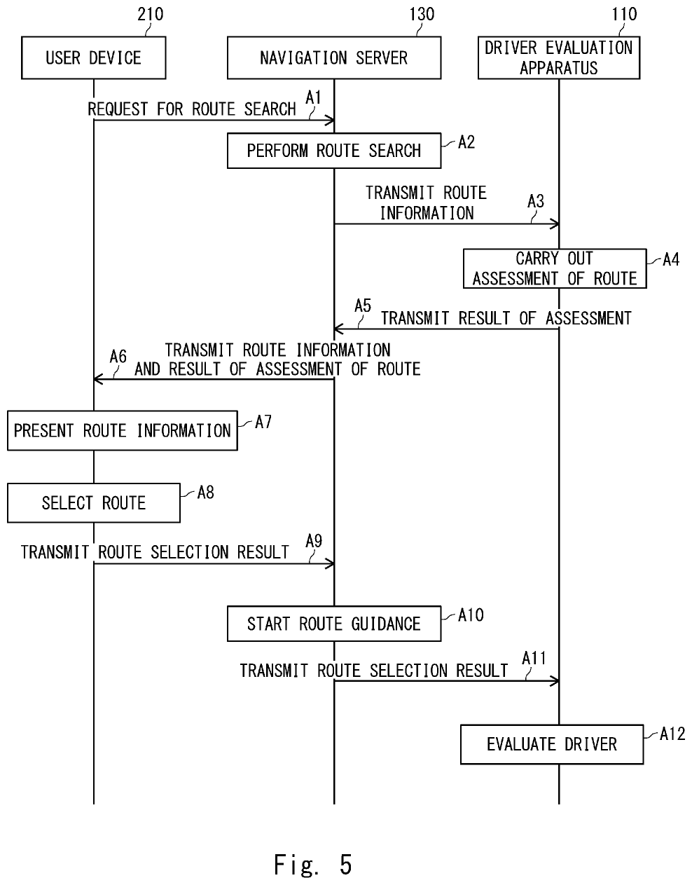

Next, the operating procedure is described. FIG. 5 shows the operating procedure (driver evaluation method) of driver evaluation in the insurance premium calculation system 100. The user operates the user device 210 and requests the navigation server 130 to perform a route search (Step A1). The navigation server 130 performs route search for a route (Step A2). The navigation server 130 transmits the route information of the searched route to the driver evaluation apparatus 110 (Step A3).

The route acquisition unit 111 (see, FIG. 3) of the driver evaluation apparatus 110 acquires the route information transmitted in Step A3. The route assessment unit 113 carries out assessment of the route based on the route information acquired by the route acquisition unit 111 and the road characteristics information acquired by the information acquisition unit 112 (Step A4). The route assessment unit 113 calculates, for example, the degree of risk in each route in Step A5. The route assessment unit 113 transmits the result of the assessment of the route carried out in Step A4 to the navigation server 130 (Step A5).

The navigation server 130 transmits the route information of the route searched in Step A2 and the result of the assessment of the route transmitted from the driver evaluation apparatus 110 in Step A5 to the user device 210 (Step A6). The user device 210 presents the route information and the result of the assessment of the route to the user (Step A7). The user refers to the presented route information and the result of the assessment of the route and selects a route (Step A8). The user device 210 transmits the route selection result indicating the selected route to the navigation server 130 (Step A9). The navigation server 130 starts route guidance of the selected route (Step A10).

The navigation server 130 transmits the route selection result to the driver evaluation apparatus 110 (Step A11). The driver evaluation unit 114 of the driver evaluation apparatus 110 evaluates the driver characteristics of the driver based on the result of the assessment of the route indicated in the route selection result (Step A12). In Step A12, the driver evaluation unit 114 generates an evaluation value of the safe driving level of the driver based on, for example, the degree of risk in the route.

When the vehicle 200 (see, FIG. 2) deviates from the route selected by the user in the route guidance, the navigation server 130 may transmit the traveling route of the vehicle 200 to the driver evaluation apparatus 110. When the driver evaluation apparatus 110 receives the traveling route of the vehicle 200 from the navigation server 130, it may re-evaluate the degree of traveling danger in the route and re-evaluate the safe driving level of the driver.

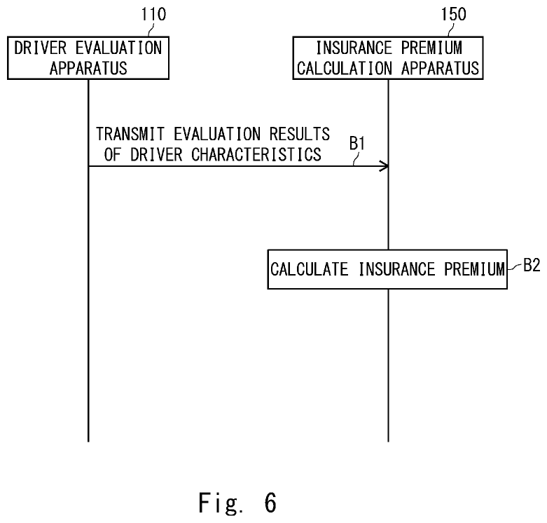

FIG. 6 shows the operating procedure of insurance premium calculation performed by the insurance premium calculation system 100. The driver evaluation apparatus 110 transmits the evaluation results of the driver characteristics evaluated in Step A12 of FIG. 5 to the insurance premium calculation apparatus 150 (Step B1). The insurance premium calculation apparatus 150 calculates the insurance premium of the user's automobile insurance based on the evaluation results of the driver characteristics (Step B2). In Step B2, the insurance premium calculation apparatus 150 calculates, for example, the discount rate to be applied at the next renewal of the user's automobile insurance. The insurance premium calculation apparatus 150 lowers the insurance premium of, for example, the user who chooses a route with a lower degree of risk.

In this example embodiment, the route assessment unit 113 carries out assessment of the degree of traveling danger in a route based on the road characteristics information, the weather data, and the time of the day. The driver evaluation unit 114 evaluates the driver characteristics based on the degree of traveling danger in the route selected by the user. The driver evaluation unit 114 evaluates, for example, that a driver who takes a safe route is a driver who tries to drive safely. In addition, the driver evaluation unit 114 evaluates, for example, that a driver who drives avoiding the weather and the time of the day when traffic accidents are prone to occur is a driver who tries to drive safely. In this example embodiment, for the evaluation of the driver, the degree of traveling danger in the route on which the user drives the vehicle 200 is used, not the driving skills. In this example embodiment, the driver evaluation apparatus 110 evaluates the user according to the driving route, so even if the user has poor driving skills, he or she can be rated high in the driver evaluation by choosing a safe route and trying to reduce the risk.

Furthermore, in this example embodiment, the insurance premium calculation apparatus 150 calculates the insurance premium of the user's automobile insurance based on the result of the aforementioned evaluation performed by the driver evaluation apparatus 110. In the related technology, since the driving skills are evaluated, a user with low driving skills cannot receive the discount of the insurance premium even when he/she does not drive in high-risk areas. In this example embodiment, the driver evaluation apparatus 110 evaluates the driver characteristics according to the degree of traveling danger in the route on which the vehicle travels, so the user can receive the discount of the insurance premium by choosing a safe route and trying to reduce the risk. Furthermore, the automobile insurance company can optimize the insurance premium by lowering the insurance premium of the user who tries to reduce the risk while driving.

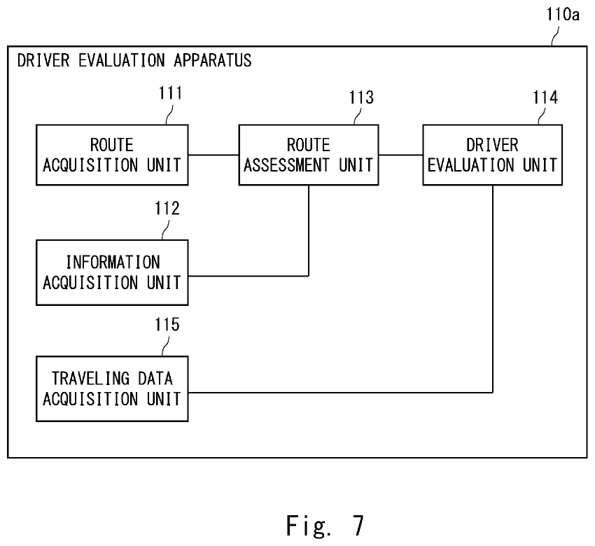

A second example embodiment of the present disclosure will be described next. FIG. 7 shows driver evaluation apparatus used in insurance premium calculation system according to the second example embodiment of the present disclosure. The configuration of insurance premium calculation system according to this example embodiment may be similar to the insurance premium calculation system 100 according to the first example embodiment shown in FIG. 2. A driver evaluation apparatus 110a used in this example embodiment differs from the driver evaluation apparatus 110 used in the first example embodiment shown in FIG. 3 in that a traveling data acquisition unit 115 is added.

The traveling data acquisition unit (traveling data acquisition means) 115 acquires traveling data indicating the traveling condition of the vehicle from the vehicle 200 (see, FIG. 2). The traveling data includes information acquired using sensors mounted on the vehicle 200, for example, information such as the speed and acceleration of the vehicle. The traveling data may include data generated by various ECUs (Electronic Control Units) mounted on the vehicle 200. The traveling data may include information indicating the operating status of the airbag, information indicating the operating status of the Anti-lock Braking System (ABS), and information indicating the operating status of the Electronic Stability Control (ESC).

In this example embodiment, the driver evaluation unit 114 evaluates the driver characteristics of the user based on the traveling data acquired by the traveling data acquisition unit 115 in addition to the degree of the traveling danger in the route on which the vehicle 200 travels. The driver evaluation unit 114 may determine whether or not the user is driving safely based on the traveling data, for example, when the route includes a traffic accident-prone area or when the route includes an area with poor pavement conditions. Whether or not the user is driving safely can be determined by comparing the speed of the vehicle in a traffic accident-prone area, for example, with the speed of the vehicle in another area and determining whether or not the speed is being reduced. The driver evaluation unit 114 may determine whether or not a driver is driving safely on a rainy day, for example, depending on whether the driver is driving at a slower speed on a rainy day compared to a sunny day.

In this example embodiment, the driver evaluation unit 114 evaluates the driver characteristics of the user based on the degree of the traveling danger in the route and the traveling data acquired from the vehicle 200. In this example embodiment, the driver evaluation apparatus 110a can evaluate the driver characteristics of the user considering not only whether the user is driving on a low-risk road but also the user's driving skills. The insurance premium calculation apparatus 150 calculates the insurance premium based on the driver characteristics evaluated by the driver evaluation apparatus 110a. In this case, the insurance premium calculation apparatus 150 can calculate the insurance premium in consideration of driving skills.

In the above example embodiment, an example is mainly described in which a user uses the user device 210, which is a portable information communication device, to request a route search from the navigation server 130, and the navigation server 130 performs route guidance. However, the present disclosure is not limited to this. For example, the user device 210 may be a navigation apparatus mounted on a vehicle 200, and the user device 210 may perform route search and route guidance. In that case, the navigation server 130 is optional. The driver evaluation apparatus 110 may acquire information such as route information from a user device 210 that is a navigation apparatus.

In the above example embodiment, an example in which the user's driver characteristics evaluated by the driver evaluation apparatus 110 are used to calculate the insurance premium of automobile insurance is explained. However, the present disclosure is not limited to this. The evaluation results of the driver evaluation apparatus 110 may also be used for other applications. For example, the evaluation results of the driver evaluation apparatus 110 may also be used to evaluate employees in operations involving the operation of vehicles, to some extent.

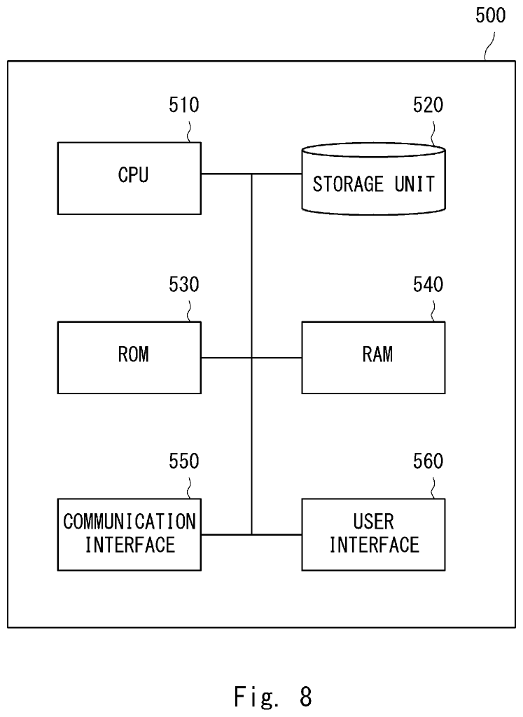

In the present disclosure, the driver evaluation apparatus 110 may be configured as a computer apparatus (a server apparatus). FIG. 8 shows an example configuration of a computer apparatus that may be used as the driver evaluation apparatus 110. The computer apparatus 500 has a control unit (CPU: Central Processing Unit) 510, a storage unit 520, ROM (Read Only Memory) 530, a RAM (Random Access Memory) 540, a communication interface (IF: Interface) 550, and a user interface 560.

The communication interface 550 is an interface for connecting the computer apparatus 500 and the communication network through wired communication means or wireless communication means. The user interface 560 includes, for example, a display unit such as a display. The user interface 560 also includes an input unit such as a keyboard, mouse, and touch panel.

The storage unit 520 is an auxiliary storage device that can hold various kinds of data. The storage unit 520 need not be a part of the computer apparatus 500, but may be an external storage device or a cloud storage device connected to the computer apparatus 500 via a network.

The ROM 530 is a nonvolatile storage device. For the ROM 530, a semiconductor memory device such as a flash memory with relatively small capacity is used. The programs executed by the CPU 510 can be stored in the storage unit 520 or the ROM 530. The storage unit 520 or the ROM 530 stores various programs for implementing functions of each part in the driver evaluation apparatus 110, for example.

The programs are stored using various types of non-transitory computer readable medium and can be supplied to the computer apparatus 500. Non-transitory computer readable medium include various types of physical storage media. Examples of non-transitory computer readable medium include magnetic recording media such as flexible disks, magnetic tapes, or hard disks, magneto-optical recording media such as magneto-optical disks, compact discs (CDs), or digital versatile disks (DVDs), and semiconductor memories such as mask ROMs, programmable ROMs (PROMs), erasable PROMs (EPROMs), flash ROMs, or RAMs. Further the programs may also be supplied to the computer using various types of temporary computer-readable media. Examples of a non-transitory computer readable medium include electrical signals, optical signals, and electromagnetic waves. A non-transitory computer readable medium can supply a program to a computer via a wired line, such as a wire and optical fiber, or via a wireless line.

The RAM 540 is a volatile storage device. Various semiconductor memory devices such as DRAM (Dynamic Random Access Memory) or SRAM (Static Random Access Memory) are used for the RAM 540. The RAM 540 can be used as an internal buffer for temporarily storing data and the like. The CPU 510 loads programs stored in the storage unit 520 or the ROM 530 into the RAM 540 and executes the programs. Functions of each part in the driver evaluation apparatus 110 can be realized by having the CPU 510 execute the programs. The CPU 510 may have an internal buffer that can temporarily store data, etc.

The example embodiments of the present disclosure have been explained in detail above, but the present disclosure is not limited to the example embodiments described above, and changes and modifications to the example embodiments described above are included in the scope of the present disclosure to the extent that they do not deviate from the gist of the present disclosure.

The whole or part of the aforementioned example embodiments can be described as, but not limited to, the following supplementary notes.

### Supplementary Note 1

A driver evaluation apparatus including:
a route acquisition means for acquiring route information of a route on which a driver drives a vehicle;
a route assessment means for carrying out assessment of a degree of traveling danger in the route based on the route information and road characteristics information of roads in the route on which the vehicle travels, and
a driver evaluation means for evaluating driver characteristics of the driver based on a result of the assessment of the route.

### Supplementary Note 2

The driver evaluation apparatus described in Supplementary Note 1, wherein the road characteristics information includes at least one of information on traffic accidents that occurred on the roads in the past, information on pavement conditions of the roads, or information on widths of the roads.

### Supplementary Note 3

The driver evaluation apparatus described in Supplementary Note 1 or 2, wherein
the route acquisition means acquires route information on a plurality of routes with a same departure place and a same destination place but different waypoints,
the route assessment means carries out assessment of the degree of the traveling danger in each of the plurality of the routes, and
the driver evaluation means evaluates the driver characteristics of the driver based on a result of the assessment of the traveling danger in a route selected by the driver among the plurality of the routes as the route on which the driver drives the vehicle.

### Supplementary Note 4

The driver evaluation apparatus described in Supplementary Note 3, wherein the route assessment means determines whether or not the vehicle is traveling on the route selected by the driver based on location information of the vehicle, and when it is determined that the vehicle is not traveling on the route selected by the driver, the route assessment means carries out re-assessment of the degree of the traveling danger in the route on which the vehicle is currently traveling.

### Supplementary Note 5

The driver evaluation apparatus described in Supplementary Note 3 or 4, wherein the driver evaluation means evaluates the driver characteristics based on a difference or a ratio between the degree of the traveling danger in the route selected by the driver among the plurality of the routes and the degree of the traveling danger in the routes not selected by the user.

### Supplementary Note 6

The driver evaluation apparatus described in any one of Supplementary Notes 1 to 5, further including a traveling data acquisition means for acquiring traveling data indicating a traveling condition of the vehicle,

wherein the driver evaluation means further evaluates the driver characteristics based on the traveling data.

### Supplementary Note 7

The driver evaluation apparatus described in any one of Supplementary Notes 1 to 6, wherein the route assessment means acquires weather data on the road on which the vehicle is traveling and further carries out assessment of the degree of the traveling danger in the route on which the vehicle is traveling based on the weather data.

### Supplementary Note 8

The driver evaluation apparatus described in any one of Supplementary Notes 1 to 7, wherein the driver evaluation means outputs a result of evaluation of the driver characteristics to an insurance premium calculation apparatus that calculates an insurance premium of an automobile insurance.

### Supplementary Note 9

An insurance premium calculation system including:
a driver evaluation apparatus that evaluates driver characteristics of a driver who is driving a vehicle; and
an insurance premium calculation apparatus,
the driver evaluation apparatus including:
   a route acquisition means for acquiring route information of a route on which the driver drives the vehicle;
   a route assessment means for carrying out assessment of a degree of traveling danger in the route based on the route information and road characteristics information of roads in the route on which the vehicle travels; and
   a driver evaluation means for evaluating the driver characteristics of the driver based on a result of the assessment of the route, and
the insurance premium calculation apparatus configured to acquire the driver characteristics from the driver evaluation apparatus and calculate an insurance premium of the vehicle driven by the driver based on the driver characteristics acquired from the driver evaluation apparatus.

### Supplementary Note 10

The insurance premium calculation system described in Supplementary Note 9, wherein the insurance premium calculation apparatus calculates a discount rate of a basic fee of the insurance premium based on the driver characteristics.

### Supplementary Note 11

The insurance premium calculation system described in Supplementary Note 9 or 10, wherein the road characteristics information includes at least one of information on traffic accidents that occurred on the roads in the past, information on pavement conditions of the roads, or information on widths of the roads.

### Supplementary Note 12

The insurance premium calculation system described in any one of Supplementary Notes 9 to 11, wherein
the route acquisition means acquires route information on a plurality of routes with a same departure place and a same destination place but different waypoints,
the route assessment means carries out assessment of the degree of the traveling danger in each of the plurality of the routes, and
the driver evaluation means evaluates the driving characteristics based on the result of the assessment of the route selected by the driver as the route on which the driver drives the vehicle among the plurality of the routes.

### Supplementary Note 13

A driver evaluation method including:
acquiring route information of a route on which a driver drives a vehicle;
carrying out assessment of a degree of traveling danger in the route based on the route information and road characteristics information of roads in the route on which the vehicle travels; and
evaluating driver characteristics of the driver based on a result of the assessment of the route.

### Supplementary Note 14

A non-transitory computer-readable medium storing a program for causing a computer to execute processes of:
acquiring route information of a route on which a driver drives a vehicle;
carrying out assessment of a degree of traveling danger in the route based on the route information and road characteristics information of roads in the route on which the vehicle travels; and
evaluating driver characteristics of the driver based on a result of the assessment of the route.

### REFERENCE SIGNS LIST

10: INSURANCE PREMIUM CALCULATION SYSTEM
30: DRIVER EVALUATION APPARATUS
31: ROUTE ACQUISITION MEANS
32: ROUTE ASSESSMENT MEANS
33: DRIVER EVALUATION MEANS
50: INSURANCE PREMIUM CALCULATION APPARATUS
100: INSURANCE PREMIUM CALCULATION SYSTEM
110: DRIVER EVALUATION APPARATUS
111: ROUTE ACQUISITION UNIT
112: INFORMATION ACQUISITION UNIT
113: ROUTE ASSESSMENT UNIT
114: DRIVER EVALUATION UNIT
115: TRAVELING DATA ACQUISITION UNIT
130: NAVIGATION SERVER
150: INSURANCE PREMIUM CALCULATION APPARATUS
170: NETWORK
200: VEHICLE
210: USER DEVICE

What is claimed is:

1. A driver evaluation apparatus comprising:
a memory storing instructions; and
a processor configured to execute the instructions to:
acquire route information of a route on which a driver drives a vehicle;
carry out assessment of a degree of traveling danger in the route based on the route information and road characteristics information of roads in the route on which the vehicle travels, and
evaluate driver characteristics of the driver based on a result of the assessment of the route.

2. The driver evaluation apparatus according to claim 1, wherein the road characteristics information includes at least one of information on traffic accidents that occurred on the roads in the past, information on pavement conditions of the roads, or information on widths of the roads.

3. The driver evaluation apparatus according to claim 1, wherein
the processor is configured to execute the instructions to:
acquire route information on a plurality of routes with a same departure place and a same destination place but different waypoints,
carry out assessment of the degree of the traveling danger in each of the plurality of the routes, and
evaluate the driver characteristics of the driver based on a result of the assessment of the traveling danger in a route selected by the driver among the plurality of the routes as the route on which the driver drives the vehicle.

4. The driver evaluation apparatus according to claim 3, wherein the processor is configured to execute the instructions to determine whether or not the vehicle is traveling on the route selected by the driver based on location information of the vehicle, and when it is determined that the vehicle is not traveling on the route selected by the driver, the processor is configured to execute the instructions to carry out re-assessment of the degree of the traveling danger in the route on which the vehicle is currently traveling.

5. The driver evaluation apparatus according to claim 3, wherein the processor is configured to execute the instructions to evaluate the driver characteristics based on a difference or a ratio between the degree of the traveling danger in the route selected by the driver among the plurality of the routes and the degree of the traveling danger in the routes not selected by the user.

6. The driver evaluation apparatus according to claim 1, the processor is further configured to execute the instructions to acquire traveling data indicating a traveling condition of the vehicle,
wherein the processor is configured to execute the instructions to further evaluate the driver characteristics based on the traveling data.

7. The driver evaluation apparatus according to claim 1, wherein the processor is configured to execute the instructions to acquire weather data on the road on which the vehicle is traveling and further carry out assessment of the degree of the traveling danger in the route on which the vehicle is traveling based on the weather data.

8. The driver evaluation apparatus according to claim 1, wherein the processor is configured to execute the instructions to output a result of evaluation of the driver characteristics to an insurance premium calculation apparatus that calculates an insurance premium of an automobile insurance.

9. An insurance premium calculation system comprising:
the driver evaluation apparatus according to claim 1; and
an insurance premium calculation apparatus comprising a memory storing instructions and a processor execute the instructions to:
acquire the driver characteristics from the driver evaluation apparatus; and
calculate an insurance premium of the vehicle driven by the driver based on the driver characteristics acquired from the driver evaluation apparatus.

10. The insurance premium calculation system according to claim 9, wherein the processor of the insurance premium calculation apparatus is configured to execute the instructions to calculate a discount rate of a basic fee of the insurance premium based on the driver characteristics.

11. The insurance premium calculation system according to claim 9, wherein the road characteristics information includes at least one of information on traffic accidents that occurred on the roads in the past, information on pavement conditions of the roads, or information on widths of the roads.

12. the insurance premium calculation system according to claim 9, wherein
the processor of the driver evaluation apparatus is configured to execute the instructions to:
acquire route information on a plurality of routes with a same departure place and a same destination place but different waypoints,
carry out assessment of the degree of the traveling danger in each of the plurality of the routes, and
evaluate the driving characteristics based on the result of the assessment of the route selected by the driver as the route on which the driver drives the vehicle among the plurality of the routes.

13. A driver evaluation method comprising:
acquiring route information of a route on which a driver drives a vehicle;
carrying out assessment of a degree of traveling danger in the route based on the route information and road characteristics information of roads in the route on which the vehicle travels; and
evaluating driver characteristics of the driver based on a result of the assessment of the route.

14. A non-transitory computer-readable medium storing a program for causing a computer to execute processes of:
acquiring route information of a route on which a driver drives a vehicle;
carrying out assessment of a degree of traveling danger in the route based on the route information and road characteristics information of roads in the route on which the vehicle travels; and
evaluating driver characteristics of the driver based on a result of the assessment of the route.
